(19) United States
(12) Patent Application Publication
(10) Pub. No.: US 2002/0041660 A1
(43) Pub. Date: Apr. 11, 2002

(54) Internet telephone system and internet telephone connecting method

(75) Inventor: Masakazu Nakamura, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/971,757

(22) Filed: Oct. 5, 2001

(30) Foreign Application Priority Data
Oct. 11, 2000 (JP) 310005/2000

(51) Int. Cl. H04M 1/64

(52) U.S. Cl. 379/88.17

(57) ABSTRACT

An internet telephone system and an internet telephone connection method is capable of lowering a rate for call of an internet telephone. The internet telephone system serves for communication between a subscriber terminal with a callee via a service provider terminal connected to an internet by an internet telephone using the internet. A telephone number of an access point for establishing connection with the service provider terminal through a telephone circuit is a freephone number of freephone service.

### BACKGROUND OF THE INVENTION

1. Field of the Invention

The present invention relates generally to an internet telephone system and an internet telephone connecting method. More particularly, the invention relates to an internet telephone for long distance call, international call and so forth through an internet.

2. Description of the Related Art

Conventionally, according to progress of internet, various network services are provided and various contents serves and various online trading system are available for use. On the other hand, concerning voice communication, it becomes typical to effect long distance call, international call through internet.

In the recent years, internet telephone systems have been developed utilizing internet technology and VoIP (Voice over Internet Protocol) technology. However, since access point available for internet telephone service is limited and basic fee is billed by normal telephone service, bursting popularity has not been gained.

In the foregoing conventional internet telephone, access points of service providers providing connection path to the internet is concentrated in capital area or large cities, available access point is limited and access from local area distant from capital or large city is relatively experience and difficult.

On the other hand, in the conventional internet telephone, since normal telephone service is used for accessing to the access point, basic fee becomes high. Furthermore, in the conventional internet telephone, while the internet is basically a flat rate data network service, cost becomes relatively high while internet is used since high cost is cased for VoIP operation.

### SUMMARY OF THE INVENTION

The present invention has been worked out in view of the problem set forth above. It is therefore an object of the present invention to provide an internet telephone system and an internet telephone connection method which can lower a rate for call of an internet telephone.

According to the first aspect of the present invention, an internet telephone system for communication between a subscriber terminal (as “a caller”) with a callee via a service provider terminal connected to an internet by an internet telephone using the internet, wherein a telephone number of an access point for establishing connection with the service provider terminal through a telephone circuit is a freephone number of freephone service.

According to the second aspect of the present invention, an internet telephone connection method for establishing communication between a subscriber terminal and a callee via a service provider terminal connected to an internet by an internet telephone using the internet, wherein a telephone number of an access point for establishing connection with the service provider terminal through a telephone circuit being a freephone number of freephone service.

Namely, in the internet telephone system according to the present invention, by using freephone for accessing to the access point, expense of the contractor to the local communication company can be reduced.

More particularly, in the internet telephone system according to the present invention, the customer desiring use of low price internet telephone makes a call to the already contracted free phone at the access point of the provider. Since the freephone is a reverse charging system, the user is not required to pay call charge to the communication (telephone) company but is required to pay call charge to the provider at a predetermined rate, such as 10 yen per 3 minutes. The provider engages big deal contract with the communication company to pay at a rate lower than the rate to be paid by the user, e.g. 7 yen per 3 minutes. The provider uses the balance, 3 yen for carrying on the internet telephone.

After calling to the access point, the user notifies the desired callee telephone number according to the voice announce. Furthermore, the user listens the commercial message for 20 seconds preliminarily prepared by the provider before dialing. By advertisement income in listening the commercial message, low price internet telephone can be realized.

In the internet telephone system according to the present invention, since the internet or IP (Internet Protocol) network is used, long distance call or international call can be made at low charge not depending upon distance to call destination. Since most internet service provider takes fixed charge system, by employing volume charge system utilizing this system, fee receipt of the internet service provider can be increased, and the user may make long distance call or international call at low charge (close to charge for local call).

Conventional internet telephone is available at limited access points, and call charge depends on the distance to the access point and time zone. Assuming that call charge for accessing the access point is for long distance call, call charge cannot be lowered even when the internet is used, for example. In contrast to this, in the internet telephone system according to the present invention, since freephone is used, the contractor is not required to pay the call charge to the local communication (telephone) company.

On the other hand, in the internet telephone system according to the present invention, the provider may be a big deal contractor of the freephone service to provide telephone service at a rate lower than normal call charge.

Furthermore, by listening advertisement preliminarily provided by the provider, the user may further lower the call charge. Since listening of the advertisement is not forced but is selective, the user may skip listening of the advertisement when quick communication is desired to directly establish connection.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

In the drawings:

FIG. 1 is a block diagram showing a construction of one embodiment of an internet telephone system according to the present invention;

FIG. 2 is an illustration showing a mechanism of one embodiment of a long distance internet telephone according to the present invention;

FIG. 3 is an illustration showing a mechanism of one embodiment of an international internet telephone according to the present invention;

FIG. 4 is an illustration showing a business model of one embodiment of a low price internet telephone according to the present invention;

FIG. 5 is an illustration showing a fee structure of one embodiment of the low price internet telephone according to the present invention;

FIG. 6A is an illustration showing a normal communication mode in another embodiment of the present invention; and

FIG. 6B is an illustration showing a discount communication mode in another embodiment of the present invention.

### DESCRIPTION OF THE PREFERRED EMBODIMENT

The present invention will be discussed hereinafter in detail in terms of the preferred embodiments of the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structure are not shown in detail in order to avoid unnecessary obscurity of the present invention.

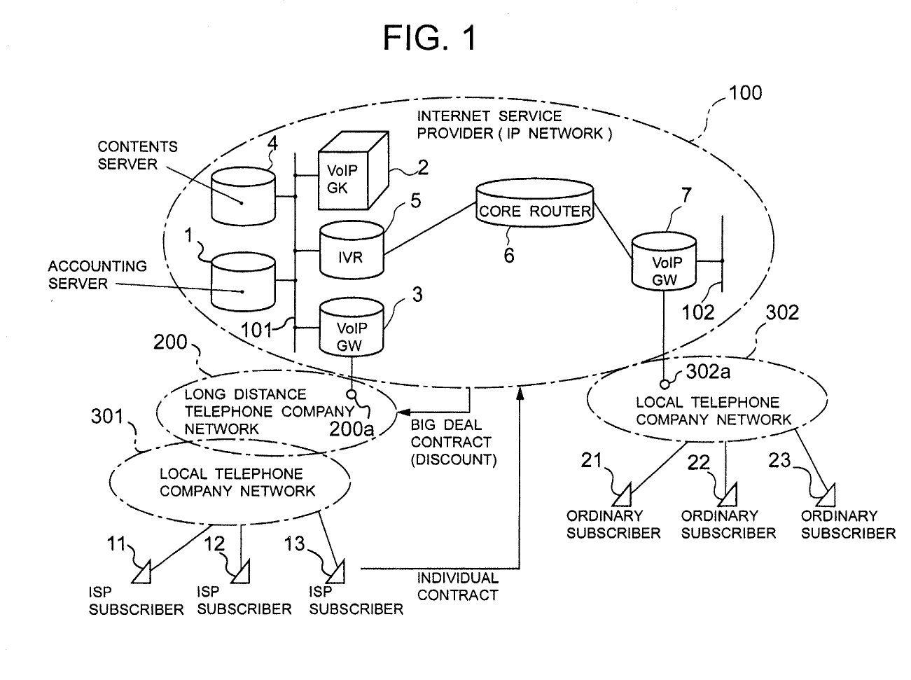

FIG. 1 is a block diagram showing a construction of one embodiment of an internet telephone system according to the present invention. In FIG. 1, one embodiment of the internet telephone system according to the present invention is constructed with ISP (Internet Service Provider) subscribers 11 to 13 subscribing local telephone company, a long distance telephone company network 200 carrying on a freephone, an internet service provider (hereinafter simply referred to as provider) 100 carrying on low price internet telephone and a local telephone company network 302 as a callee.

The ISP subscribers 11 to 13 having contracts with the provider 100 is connected to a local telephone company network 301. Call from the ISP subscriber 11 reaches a VoIP GW (Voice over Internet protocol Gateway) 3 of the provider 100 via the local telephone company network 301 and a long distance telephone company network 200.

Here, the provider 100 is constructed with a VoIP GW3 and 7 for converting call into a packet, a VoIP GK (Voice over Internet Protocol Gatekeeper) 2 controlling the call, an accounting server 1 storing call information, a contents server 4 storing commercial message (CM), a core router forming an IP network, IVR (Interactive Voice Recorder: Automatic Voice Responding Device) 5. Respective components are connected to system buses 101 and 102.

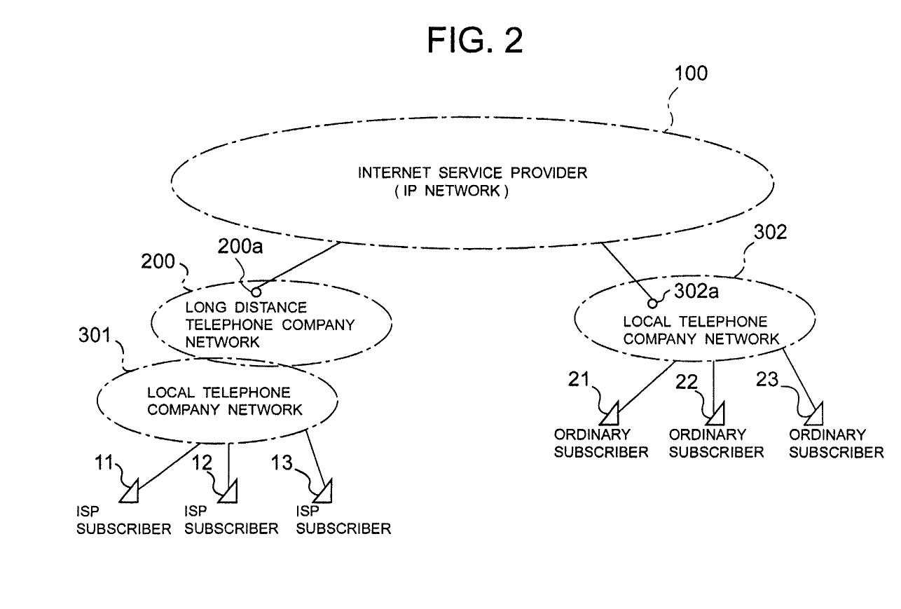

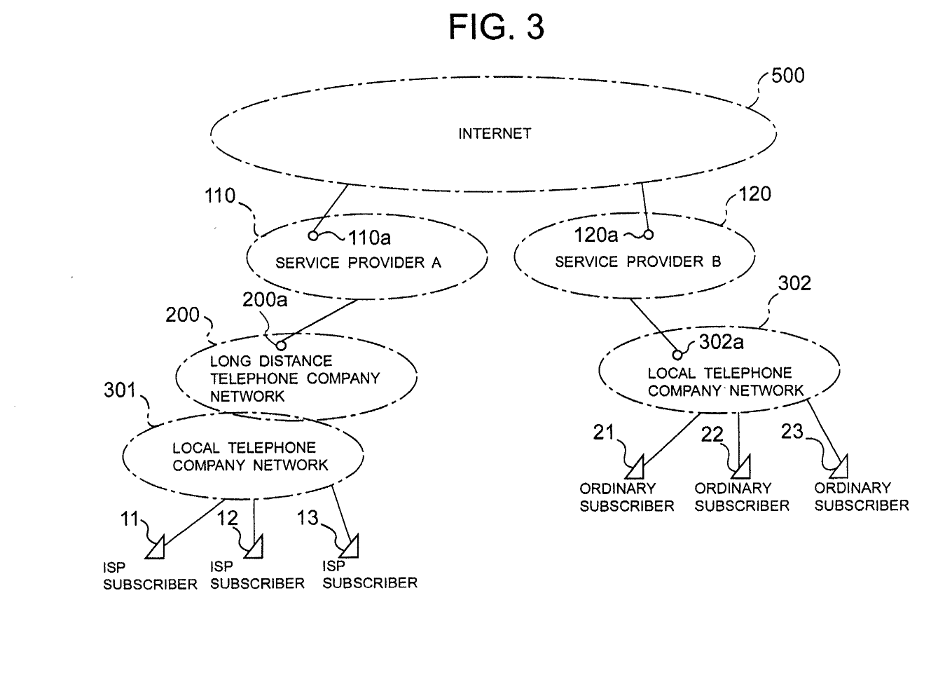

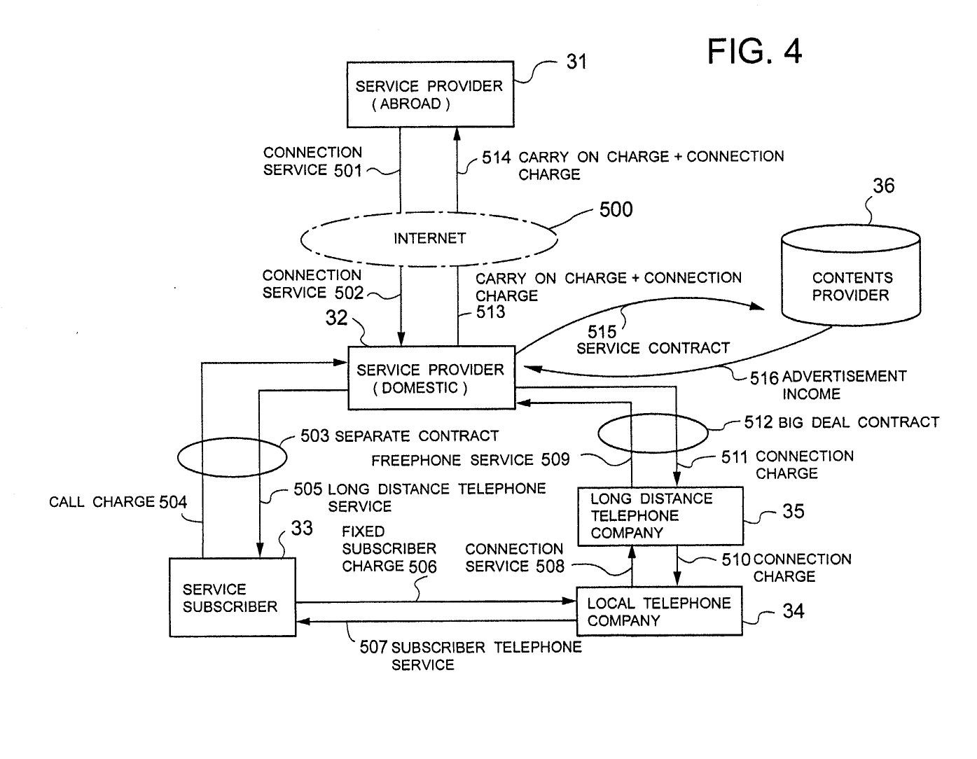

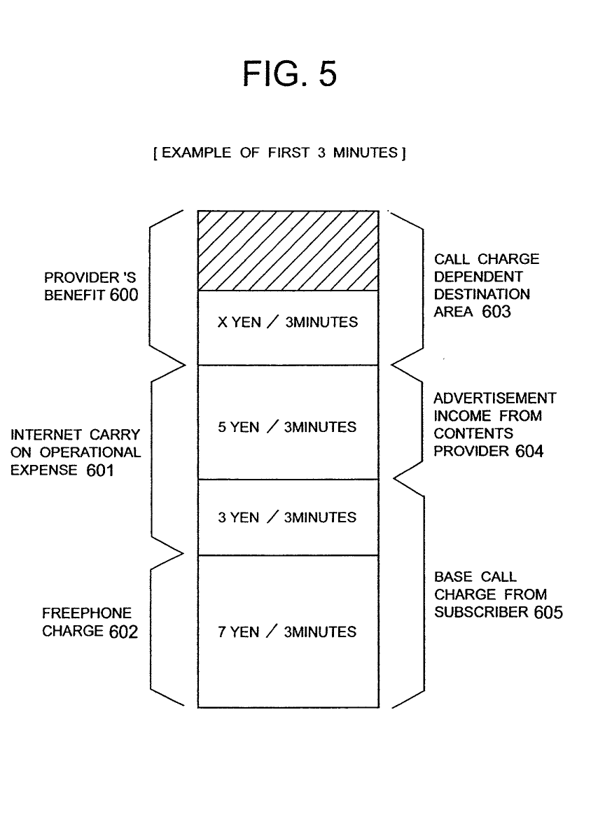

FIG. 2 is an illustration showing a mechanism of one embodiment of a long distance internet telephone according to the present invention, FIG. 3 is an illustration showing a mechanism of one embodiment of an international internet telephone according to the present invention, FIG. 4 is an illustration showing a business model of one embodiment of a low price internet telephone according to the present invention, and FIG. 5 is an illustration showing a fee structure of one embodiment of the low price internet telephone according to the present invention. Operation of one embodiment of the internet telephone system will be discussed with reference to FIGS. 1 to 5.

Now, when the ISP subscriber 11 wants to use internet telephone service, the ISP subscriber 11 dials to a telephone number for freephone of an access point 200a designated by the provider 100. Call charge will never be charged for freephone.

The provider engages a big deal contract of freephone with a long-distance telephone company network 200 and charge corresponding to call period is paid. Because of big deal contract, a big deal discount is applied. For example, when local call is 10 yen per 3 minutes, the provider 100 will pay 6 or 7 yen per 3 minutes to the long-distance telephone company network 200. In this case, the provider directly corrects call charge of 10 yen per 3 minutes from ISP subscribers 11 to 13.

The provider 100 uses a difference 3 yen (per 3 minutes) of the call change collected from the subscribers and the charge to be paid to the long-distance telephone company network 200, as operational expense of the internet telephone. Here, call charge of 10 yen per 3 minutes is mere example and can be set at a call charge corresponding to destination by charging more than 10 yen per 3 minutes depending upon distance to the destination.

Call made by the ISP subscriber 11 reaches to IVR 5 of the VoIP GW3 of the provider 100. The ISP subscriber 11 dials a desired telephone number of callee according voice guidance transmitted from the IVR 5.

Furthermore, the ISP subscriber 11 is required to select to listen commercial message (CM) or directly establish connection, according to guidance of the IVR 5. When listening of commercial message is selected, the ISP subscriber 11 listens commercial message for about 20 seconds provided by the provider 100. The commercial messages are stored in the contents server 4. The appropriate commercial message is selected among stored messages adapting to sexuality, age, taste and so forth of the contractor. It should be noted that when the commercial message is listened, discounting is applied for the call charge for 20%, and otherwise, normal call charge is applied.

When the commercial message ends, call process is advanced to connection step. Voice message from the ISP subscriber 11 is converted into packets and is transmitted to VoIP GW 7 of the callee as designated by the VoIP GK 2.

The VoIP GW 7 of the callee restores the packet voice into the original voice signal and then establishes connection with the local telephone company network 302. Then, the local telephone company network 302 establishes connection with the designated subscriber (ordinary subscribers 21 to 23) as callee according to a predetermined routing rule. When the designated ordinary subscriber 21-23 responds to the call, communication is started. Application of call charge is performed by caller side accounting server 1. Since charging not depending on the distance is possible on the internet, low price internet telephone can be realized.

In FIG. 2, the ISP subscribers 11 to 13 of the provider 100 is connected to the local telephone company network 301. The ISP subscribers 11 to 13 are connected to the access point 200a of the provider using freephone of the long distance telephone company network 200. The provider 100 uses own IP network to transport the packet voice signal to the access point 302a on the callee side. The provider 100 is directly connected to the local telephone company network 302 to establish call connection to the ordinary subscribers 21 to 23 as routed on the basis of telephone number.

In FIG. 3, the ISP subscribers 11 to 13 are connected to the access point 110a of the provider A110 utilizing free phone of the long distance telephone company network 200. The provider A110 uses internet 500 to establish connection with an already contracted provider B120 in the abroad. The packet voice signal is transferred to the access point 120a of the callee side provider B120 via the internet 500. The transferred voice signal is transferred to the ordinary subscribers 21 to 23 via the local telephone company network 302 of destination country.

In FIG. 4, a service subscriber 33 engages with separate contract 503 with the provider (domestic) 32. The service subscriber 33 receives long distance telephone service 505 and directly pay call charge 504 to the provider (domestic) 32 as service charge for the call.

On the other hand, the service subscriber 33 receives the subscriber telephone service 507 of the local telephone company 34. Furthermore, the provider (domestic) 32 engages a contract for freephone service 509 of the long distance telephone company 35.

Accordingly, the service subscriber 33 is not required to pay call charge 504 required to be paid upon call to the long distance telephone company 35 (of course, to the local telephone company 34). The provider (domestic) 32 has a big deal contract 512 of freephone with the long distance telephone company 35 to enjoy special privilege of big deal discount. However, the provider (domestic) 32 collects ordinary local call charge or higher from the service subscriber 33 to carry on the internet telephone by the balance amount therebetween.

It should be noted that, in case of the international call, the provider (domestic) 32 engages connection services 510 and 502 with the service provider (abroad) 31 in the abroad via the internet 500 and pays carry on charge plus connection charge 513 and 514. In this case, the provider (domestic) 32 collects the carry on charge from the service subscriber 33.

Since the internet telephone does not depend on the distance, service can be provided with small fixed charge. However, in the shown model, volume charge system depending upon time and destination is applied to obtain carry on charge of the provider (domestic) 32.

On the other hand, the provider (domestic) 32 engages service contract 515 with the contents provider 36 to obtain advertisement income 516 by making the service subscriber 33 listen the commercial message provided from the contents provider 36.

In FIG. 5, basic call charge 605 from the subscriber is set at 10 yen per 3 minutes. Among the basic call charge 605, 7 yen is overhead cost 602 for freephone, and remaining 3 yen is spent as a part of carry on overhead cost of the internet telephone.

On the other hand, by obtaining the advertisement income 604 at a rate of 5 yen per 3 minutes from the contents provider, the internet telephone is carried on with the overhead cost of 8 yen per 3 minutes in total. Furthermore, by collecting call charge 603 at a rate of x yen per 3 minutes per each destination area from the subscribers, the benefit of the provider is keeped.

Conventionally, the access point is limited to the fixed point in the internet telephone system. Therefore, the call charge is depending on the distance from the call point to the access point and the calling time. Assuming that call charge to the access point is dealt as long-distance call, call charge cannot be made cheaper even when the internet is used. In contrast to this, in one embodiment of the internet telephone system according to the present invention, since the free phone is used as set forth above, the contractor is not required to bear call charge of the local telephone company.

On the other hand, in one embodiment of the internet telephone system according to the present invention, since the provider becomes big deal contractor of the free phone, telephone service can be provided at lower rate of charge than normal call charge. Accordingly, in one embodiment of the internet telephone system in accordance with the present invention, call charge of the internet telephone can be lowered.

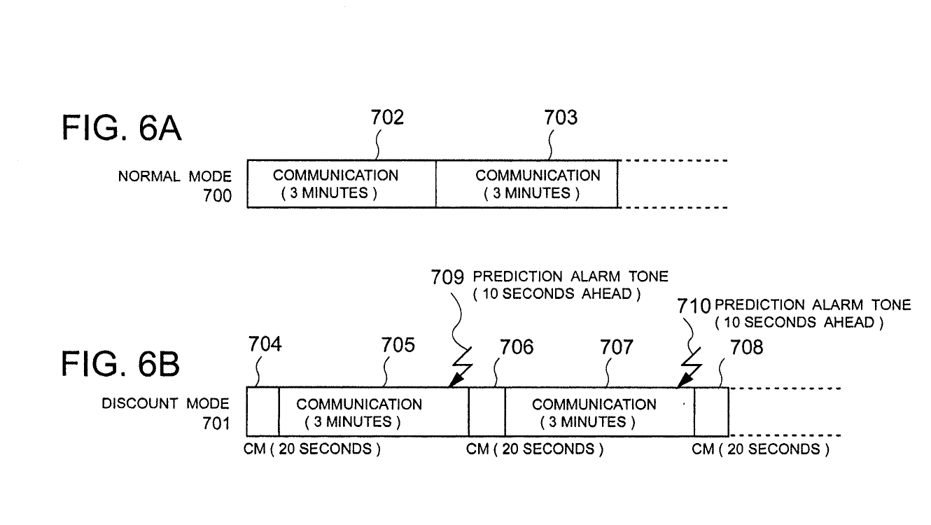

FIGS. 6A and 6B are illustration showing call modes of another embodiment of the internet telephone according to the present invention.

FIG. 6A shows a call mode in a normal call mode 700 and FIG. 6B shows a call mode in a discount call mode 701. Another embodiment of the internet telephone will be discussed with reference to FIGS. 6A and 6B. It should be noted that, in another embodiment of the present invention, the ISP subscriber is the same as one embodiment of the present invention shown in FIG. 1, up to the step where the call is made to the access point of the provider.

Call made by the ISP subscriber 11 reaches the IVR 5 of the VoIP GW 3 of the provider 100. According to guidance of the IVR 5, the ISP subscriber 11 dials the designed telephone number of the callee. Furthermore, the ISP subscriber 11 is required to select to listen commercial message according to guidance of the IVR 5 or to establish direct connection.

When listening of commercial message is selected, the ISP subscriber 11 listens the commercial message provided by the provider 100 for about 20 seconds. The commercial messages are stored in the contents server 4. The appropriate commercial message is selected among stored messages adapting to sexuality, age, taste and so forth of the contractor. It should be noted that when the commercial message is listened, discounting is applied for the call charge for 20%, and otherwise, normal call charge is applied.

When the commercial message ends, call process is advanced to connection step for establishing connection according to a predetermined procedure to start communication. When communication extends to be close to 3 minutes, a prediction alarm tone (bleep sound) 709 is given to require the caller to select continue communication in normal mode 700 in next unit period (3 minutes in this example) or in discount mode 701 with listening commercial message.

When the caller selects the normal mode 700, a predetermined number is depressed. On the other hand, when the caller selects the discount mode 701, another predetermined number is depressed. When the discount mode 701 is selected, the caller is required to listen about 20 seconds of commercial message after end of communication for 3 minutes. Application of call charge is performed by the accounting server 1 on caller side to realize low price international telephone adapting to needs of the service subscriber.

As set forth above, for the user, the call charge to be paid can be lowered by listening of commercial message preliminarily provided by the provider before call connection. Listening of commercial message is not essential and is not forced to permit selection by the user. Therefore, when the user desire to eliminate listening of commercial message, it is possible to select direct connection skipping listening of the commercial message.

As set forth above, with the present invention, in the internet telephone system for communication between the subscriber terminal and callee via the service provider terminal through internet by internet telephone using internet telephone system, freephone number is set as the telephone number of the access point for establishing connection with the service provider terminal via the telephone circuit, to permit lowering of call charge of the internet telephone.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

What is claimed is:

1. An internet telephone system for communication between a subscriber terminal with a callee via a service provider terminal connected to an internet by an internet telephone using said internet, wherein a telephone number of an access point for establishing connection with said service provider terminal through a telephone circuit is a freephone number of freephone service.

2. An internet telephone system as set forth in claim 1, wherein a charge system of said freephone is incorporated in a charge system of said internet telephone.

3. An internet telephone system as set forth in claim 1, which further comprises means for notifying to said subscriber terminal requiring selection whether commercial message is listened or not before establishing connection of said internet telephone.

4. An internet telephone system as set forth in claim 3, wherein when listening of said commercial message is selected, discounting is applied for call charge for said subscriber terminal.

5. An internet telephone system as set forth in claim 3, wherein an advertisement income obtained from listening of said commercial message is included in an operational expense of said internet telephone.

6. An internet telephone connection method for establishing communication between a subscriber terminal and a callee via a service provider terminal connected to an internet by an internet telephone using said internet, wherein a telephone number of an access point for establishing connection with said service provider terminal through a telephone circuit is a freephone number of freephone service.

7. An internet telephone connection method as set forth in claim 6, wherein a charge system of said freephone is incorporated in a charge system of said internet telephone.

8. An internet telephone connection method as set forth in claim 6, which further comprises means for notifying to said subscriber terminal requiring selection whether commercial message is listened or not before establishing connection of said internet telephone.

9. An internet telephone connection method as set forth in claim 8, wherein when listening of said commercial message is selected, discounting is applied for call charge for said subscriber terminal.

10. An internet telephone connection method as set forth in claim 8, wherein an advertisement income obtained from listening of said commercial message is included in an operational expense of said internet telephone.

11. An internet telephone system as set forth in claim 1, wherein a subscriber using said subscriber terminal pays call charge to a service provider using said service provider terminal for access to said access point, said service provider pays call charge to a telephone company carrying on said freephone service for call from said subscriber terminal to said access point, and said call charge paid by said service provider is lower than said call charge paid by said subscriber.

12. An internet telephone system as set forth in claim 11, wherein said service provider include a balance between said call charge collected from said subscriber and said call charge paid to said telephone company carrying on said freephone service in operational expense.

13. An internet telephone connection method as set forth in claim 6, wherein a subscriber using said subscriber terminal pays call charge to a service provider using said service provider terminal for access to said access point, said service provider pays call charge to a telephone company carrying on said freephone service for call from said subscriber terminal to said access point, and said call charge paid by said service provider is lower than said call charge paid by said subscriber.

14. An internet telephone connection method as set forth in claim 13, wherein said service provider include a balance between said call charge collected from said subscriber and said call charge paid to said telephone company carrying on said freephone service in operational expense.
